(19) United States
(12) Patent Application Publication
(10) Pub. No.: US 2009/0119026 A1
(43) Pub. Date: May 7, 2009

(54) PORTABLE MULTI-IONS SENSING SYSTEM AND FABRICATION THEREOF

(75) Inventors: Shen-Kan Hsiung, Tao-yuan (TW); Jung-Chuan Chou, Tao-Yuan (TW); Tai-Ping Sun, Tao-Yuan (TW); Nien-Hsuan Chou, Tao-Yuan (TW); Gin-Chou Yang, Tao-Yuan (TW)

Correspondence Address: WPAT, PC, 7225 BEVERLY ST., ANNANDALE, VA, 22003, US

(73) Assignee: CHUNG YUAN CHRISTIAN UNIVERSITY, Tao-Yuan (TW)

(21) Appl. No.: 11/933,809

(22) Filed: Nov. 1, 2007

(51) Int. Cl. G01N 31/00; G01N 27/416; G06F 19/00

(52) U.S. Cl. 702/25; 324/438

(57) ABSTRACT

A portable multi-ions sensing system is provided. The sensing system includes: a sensing unit for sensing a pH value and a plurality of ion concentrations of a solution and outputting a sensing signal, wherein the sensing unit includes: a substrate; an ITO layer on the substrate; a sensing layer on the ITO layer and connected with an extended lead; a packaging layer encapsulating the sensing layer, the ITO layer and a portion of the substrate with a sensing window for exposing a portion of the sensing layer; a multi-ions selective layer on the portion of the sensing layer exposed by the sensing window for sensing the ion concentrations; and a reference electrode for providing a reference potential for the sensing layer; an analog signal processing unit for receiving, filtering, amplifying and adjusting the level of the sensing signal and outputting a front-end signal; a microcontroller unit for receiving and performing analog/digital converting and two-point correcting processes on the front-end signal and outputting a measurement data; and a real-time display unit for receiving and displaying the measurement data.

### BACKGROUND OF THE INVENTION

1. Field of the Invention

The present invention relates to a system for sensing ion concentration and fabrication method thereof and, more particularly, a portable multi-ions sensing system and fabrication method thereof.

2. Description of the Prior Art

Ion Sensitive Field Effect Transistor (ISFET) was a micro-sensing element invented in the 70s and has since received much attention. There are over 600 related publications in these 30 years. There are over 150 research articles directed to other related elements, such as Enzyme Field Effect Transistors (EnFETs) and Immune Field Effect Transistors (IMFETs). [P. Bergveld, “Thirty years of ISFETOLOGY: What happened in the past 30 years and what may happen in the next 30 years”, Sensors and Actuators B, Vol. 88, pp. 1-20, 2003.]

Additionally, glass electrodes are replaced by ISFET for measuring pH value and ion concentration (e.g. Na⁺, K⁺, Cl⁻, NH4⁺, Ca2⁺ etc.) [Miao Yuqing, Guan Jianguo, and Chen Jianrong, “Ion sensitive field effect transducer-based biosensors”, Biotechnology Advances, Vol. 21, pp. 527-534, 2003.]. The earliest application is proposed by P. Bergveld, where primarily the metal gate of a Metal Oxide Semiconductor Field Effect Transistor (MOSFET) is removed, and an element of SiO₂ layer and a reference electrode are then disposed in solution, such that current flowing through the element varies with hydrogen ion concentration. This functions similarly to a glass electrode, so it is able to sense pH value. [Jen-Bin Jheng, Yong-Li Lee, and Hong Kao, “Ion Sensitive Field Effect Transistor and Applications Thereof”, Analysis Chemistry, vol. 23, 7^{th} issue, pp. 842-849, 1995.; Shi-ShawnWu, Duan Lu, Kuei-Hwa Wang, “Chemical Sensor Measurement”, Sensor Technology, 3^{rd} issue, pp. 57-62, 1990.]

There have been a few commercialized ISFET sensing elements on the market, for example, ISFET pH meters, but stability and lifetime of these elements, for example, time drift and hysteresis, are still issues that need to be addressed. Extended Gate Field Effect Transistor (EGFET) used in the present invention is another type of ISFET, and in which the FET is separated from the chemical measuring environment and a chemical sensing film is deposited on the end of a signal terminal extended from the gate region of the FET, and electrical and chemical active regions are separately packaged. As a result, EGFET can be more easily packaged and reserved and more stable than the traditional ISFET. [Han-Chu Liao, “New Correction and Compensation Circuit Applied to Biological Sensors”, June 2004, Chung-Yuan Christian University Electrical Engineering Department, Master Thesis, pp. 11-29]

Recently, much research has been focused on the characteristics of EGFET, such as element design [Li Te Yin, Jung Chuan Chou, Wen Yaw Chung, Tai Ping Sun, and Shen Kan Hsiung, “Study on Separate Structure Extended Gate H+-ion Sensitive Field Effect Transistor on a Glass Substrate”, Sensors and Actuators B, Vol. 71, 106-111, 2000.; Li Te Yin, Jung Chuan Chou, Wen Yaw Chung, Tai Ping Sun, and Shen Kan Hsiung, “Study of Indium Tin Oxide Thin Film for Separative Extended Gate ISFET”, Materials Chemistry and Physics, Vol. 70, pp. 12-16, 2001.; Li Te Yin, Jung Chuan Chou, Wen Yaw Chung, Tai Ping Sun, Kuang Pin Hsiung, and Shen Kan Hsiung, “Study on Glucose ENFET Doped with MnO2 Powder”, Sensors and Actuators B, Vol. 76, pp. 187-192, 2001.; Li-Da Yin, “Research Using Ion-Sensitive Field Effect Transistor as Biological Sensors”, June 2001, Chung-Yuan Christian University Medical Engineering Department, Doctoral Thesis, pp. 76-108.]; characteristic analysis [Yong-Long Qin, “Research on Fabricating Extended Field Effect Transistor Using CMOS Fabrication Technique and Signal Processing Integrated Circuit Thereof”, June 2001, Chung-Yuan Christian University Electrical Engineering Department, Doctral Thesis, pp. 36-44; Jia-Qi Chen, “Disposable Urea Sensors and Pre-amplifier”, June 2006, Chung-Yuan Christian University Electrical Engineering Department, Master Thesis, pp. 51-80; Jia Chyi Chen, Jung Chuan Chou, Tai Ping Sun, and Shen Kan Hsiung, “Portable Urea Biosensor based on the Extended-Gate Field Effect Transistor”, Sensors and Actuators B, Vol. 91, pp. 180-186, 2003.; Chung We Pan, Jung Chuan Chou, I Kone Kao, Tai Ping Sun, and Shen Kan Hsiung, “Using Polypyrrole as the Contrast pH Detector to Fabricate a Whole Solid-State pH Sensing Device”, IEEE Sensors Journal, Vol. 3, pp. 164-170, 2003.; Jui Fu Cheng, Jung Chuan Chou, Tai Ping Sun, and Shen Kan Hsiung, “Study on the Chloride Ion Selective Electrode based on the SnO2/ITO Glass”, Proceedings of The 2003 Electron Devices and Materials Symposium (EDMS), National Taiwan Ocean University, Keelung, Taiwan, R. O. C., pp. 557-560, 2003.; Jui Fu Cheng, Jung Chuan Chou, Tai Ping Sun, and Shen Kan Hsiung, “Study on the Chloride Ion Selective Electrode based on the SnO2/ITO Glass and Double-Layer Sensor Structure”, Proceedings of The 10th International Meeting on Chemical Sensors, Tsukuba International Congress Center, Tsukuba, Japan, pp. 720-721, 2004.]; and time drift and hysteresis characteristics etc. [Han-Chu Liao, “New Correction and Compensation Circuit Applied to Biological Sensors”, June 2004, Chung-Yuan Christian University Electrical Engineering Department, Master Thesis, pp. 11-29; Chu Neng Tsai, Jung Chuan Chou, Tai Ping Sun, and Shen Kan Hsiung, “Study on the Hysteresis of the Metal Oxide pH Electrode”, Proceedings of The 10th International Meeting on Chemical Sensors, Tsukuba International Congress Center, Tsukuba, Japan, pp. 586-587, 2004.; Chu Neng Tsai, Jung Chuan Chou, Tai Ping Sun, and Shen Kan Hsiung, “Study on the Sensing Characteristics and Hysteresis Effect of the Tin Oxide pH Electrode”, Sensors and Actuators B, Vol. 108, pp. 877-882, 2005.] Characteristics of the sensing elements are well understood in the art, so the multi-ions sensor proposed by the present invention is combined with the embedded technique, [Microchip Technology Inc., “http://www.microchip.com”, PIC18F452 datasheet; Microchip Technology Inc., “http://www.microchip.com”, MPLAB C18 C Compiler User's Guide.] so the present invention provides a portable multi-ions sensing system of with a LCD real-time display, USB and USART data transmission functionalities.

### SUMMARY OF THE INVENTION

A portable multi-ions sensing system is provided. The sensing system includes: a sensing unit for sensing a pH value and a plurality of ion concentrations of a solution and outputting a sensing signal, wherein the sensing unit includes: a substrate; an ITO layer on the substrate; a sensing layer on the ITO layer and connected with an extended lead; a packaging layer encapsulating the sensing layer, the ITO layer and a portion of the substrate with a sensing window for exposing a portion of the sensing layer; a multi-ions selective layer on the portion of the sensing layer exposed by the sensing window for sensing the ion concentrations; and a reference electrode for providing a reference potential for the sensing layer; an analog signal processing unit for receiving, filtering, amplifying and adjusting the level of the sensing signal and outputting a front-end signal; a microcontroller unit for receiving and performing analog/digital converting and two-point correcting processes on the front-end signal and outputting a measurement data; and a real-time display unit for receiving and displaying the measurement data.

### BRIEF DESCRIPTION OF THE DRAWINGS

The accompanying drawings incorporated in and forming a part of the specification illustrate several aspects of the present invention, and together with the description serve to explain the principles of the disclosure. In the drawings:

FIG. 1 is a schematic system block diagram of a portable multi-ions sensing system according to a preferred embodiment of the present invention;

FIG. 2 is a cross-sectional schematic diagram of a sensing unit according to a preferred embodiment of the present invention;

FIG. 3 is an equivalent circuit diagram of an analog signal processing unit according to a preferred embodiment of the present invention;

FIG. 4 is a data processing flow diagram of a microcontroller unit according to a preferred embodiment of the present invention;

FIG. 5 is an equivalent circuit diagram depicting connectivity between a microcontroller unit and a real-time display unit and a data transmitting unit according to a preferred embodiment of the present invention;

FIG. 6 is a schematic diagram depicting the system according to a preferred embodiment of the present invention;

FIG. 7A is a graph depicting steady-state output voltage for a pH electrode of a preferred portable multi-ions sensing system of the present invention;

FIG. 7B is a graph depicting steady-state output voltage for a potassium ion selective electrode of a preferred portable multi-ions sensing system of the present invention;

FIG. 7C is a graph depicting steady-state output voltage for a sodium ion selective electrode of a preferred portable multi-ions sensing system of the present invention;

FIG. 7D is a graph depicting steady-state output voltage for a chloride ion selective electrode of a preferred portable multi-ions sensing system of the present invention;

FIG. 8A is a graph depicting a correction curve for the pH electrode of a preferred portable multi-ions sensing system of the present invention;

FIG. 8B is a graph depicting a correction curve for the potassium ion selective electrode of a preferred portable multi-ions sensing system of the present invention;

FIG. 8C is a graph depicting a correction curve for the sodium ion selective electrode of a preferred portable multi-ions sensing system of the present invention; and

FIG. 8D is a graph depicting a correction curve for the chloride ion selective electrode of a preferred portable multi-ions sensing system of the present invention.

### DETAILED DESCRIPTION OF THE PREFERRED EMBODIMENTS

Detailed steps and constituents are given below to assist in the understanding the present invention. Obviously, the implementations of the present invention are not limited to the specific details known by those skilled in the art. On the other hand, well-known steps or constituents are not described in details in order not to unnecessarily limit the present invention. Detailed embodiments of the present invention will be provided as follow. However, apart from these detailed descriptions, the present invention may be generally applied to other embodiments, and the scope of the present invention is thus limited only by the appended claims.

One main objective of the present invention realizes a portable multi-ions sensing system using a separative tin dioxide pH electrode combined with ion selective layer (film) and the embedded technique. One primary function, among others, is to provide real-time measured results on a LCD and data transmission with computers (i.e. USB and RS232 transmission lines). In terms of applications, the present system can not only be applied to pH sensing, but also to ions (e.g. potassium, sodium and chloride) sensing when incorporated with an ion selective layer (film). Thereby, clinical, biochemical-signal and environmental sensing applications can be increased.

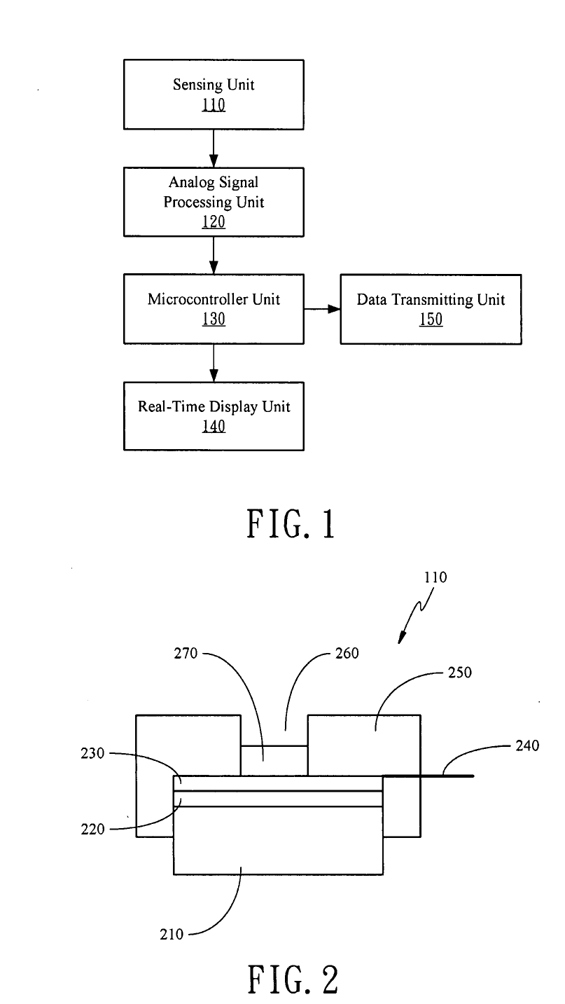

Referring to FIG. 1, a schematic system block diagram of a preferred embodiment of the present invention is shown. In this embodiment, the portable multi-ions sensing system includes: a sensing unit 110, an analog signal processing unit 120, a microcontroller unit 130 and a real-time display unit 140. The sensing unit 110 is used to sense pH value and a plurality of ion concentrations of a solution and output a sensing signal. The analog signal processing unit 120 is used to receive, filter, amplify and adjust the level of the sensing signal outputted by the sensing unit 110 and output a front-end signal. The microcontroller unit 130 is used to receive and perform analog/digital conversion and two-point correction on the front-end signal outputted by the analog signal processing unit 120 to output a measurement data. The real-time display unit 140 is used to receive and display the measurement data outputted by the microcontroller unit 130. In this embodiment, the real-time display unit 140 includes a thin display, such as a Liquid Crystal Display (LCD). In another embodiment, the portable multi-ions sensing system further includes a data transmitting unit 150 for transmitting the measurement data outputted by the microcontroller 130 out of the portable multi-ions sensing system to, for example, a personal computer. In this embodiment, the transmission interface of the data transmission unit 150 includes a Universal Serial Bus (USB) and/or a Universal Synchronous Asynchronous Receiver Transmitter (USART).

Referring to FIG. 2, which shows a cross-sectional schematic diagram of the sensing unit 110 according to a preferred embodiment of the present invention. A substrate 210, in this embodiment, includes an insulating substrate, such as a ceramic substrate or a glass substrate, wherein the glass substrate is preferred. An indium tin oxide (ITO) layer 220 is disposed on the substrate 210, wherein the thickness of the ITO layer 220 is about 230 angstrom (Å), but the present invention is not limited to this thickness. A sensing layer 230 is on the ITO layer 220 and connected to an extended lead 240, wherein the sensing layer 230 includes tin dioxide (SnO₂) and the thickness of which is preferably about 2000 Å. The extended lead 240 is preferably silver wires. The sensing layer 230, ITO layer 220 and a portion of the substrate 210 is encapsulated by a packaging layer 250. The packaging layer 250 has a sensing window 260 for exposing a portion of the sensing layer 230, wherein the packaging layer 250 includes epoxy resin and the sensing window 260 preferably has an area of 2×2 mm². In this embodiment, the portion of the substrate 210 encapsulated by the packaging layer 250 refers to a completely encapsulated portion near the interface between the ITO layer 220 and the substrate 210, and the extended lead passes through the packaging layer 250.

A multi-ions selective layer 270 is disposed on the sensing layer 230 in the sensing window 260 for sensing a plurality of ion concentrations of a solution, wherein the multi-ions selective layer 270 includes a potassium ion selective layer (film), a sodium ion selective layer (film) and/or a chloride ion selective layer (film) to form a potassium ion selective electrode, a sodium ion selective electrode and/or a chloride ion selective electrode for sensing concentrations of the potassium ions, sodium ions and/or chloride ions. The sensing unit 110 may further include a reference electrode for providing a reference potential for the sensing unit 110, as described later.

In this embodiment, the sensing unit 110 is easier to fabricate and package at a lower cost, which is suitable for disposable sensors applications. The sensing unit 110 includes a separative extended gate ion sensor as the base with an potassium, sodium and chloride ion selective layer attached thereon to form a multi-ion sensor that can sense pH value, potassium, sodium and chloride ion concentrations. The method of fabrication is as follows:

(A) An ITO layer is formed on a substrate, wherein the thickness of the ITO layer is preferably 230 Å, but the present invention is not limited to this thickness. The substrate is an insulating substrate, e.g. a ceramic substrate or a glass substrate. However, a glass substrate is preferred.

(B) The substrate with the ITO layer is placed in an ultrasonic vibrators filled with methanol solution and deionized (DI) water, respectively. The duration of vibration is preferably 15 minutes each.

(C) A sensing layer is formed on the ITO layer, including growing a tin dioxide layer by physical vapor deposition. A radio frequency sputter is preferred. The target is tin dioxide. A mixture gas is provided while the substrate is maintained at a certain temperature. The mixture gas is consisted of argon and oxygen gas. The temperature of the substrate during growth of the tin dioxide layer is kept at 150 ≡, the deposition pressure is at about 20 mTorr, the radio frequency power is about 50 Watts, the preferred thickness of the sensing layer (tin dioxide) is about 2000 Å, and the ratio of argon and oxygen is 4:1.

(D) Lead connection and packaging are performed. An extended lead is attached to the sensing layer by silver gel, and the sensing layer, the ITO layer and a portion of the substrate are encapsulated by a packaging material (packaging layer). The packaging layer includes a sensing window that exposes a portion of the sensing layer, wherein the extended lead is preferably a silver wire, the packaging layer is preferably epoxy resin, and the size of the sensing window is preferably 2×2 mm².

(E) A multi-ions selective layer is formed on the sensing layer in the sensing window, wherein the multi-ions selective layer includes potassium, sodium and chloride ion selective layers (films) as potassium, sodium and chloride ion selective electrode for sensing the potassium, sodium and chloride ion concentration of a solution.

(F) A reference electrode is used for providing a stable reference potential, wherein the reference electrode includes a glass electrode made of silver/silver chloride, for example.

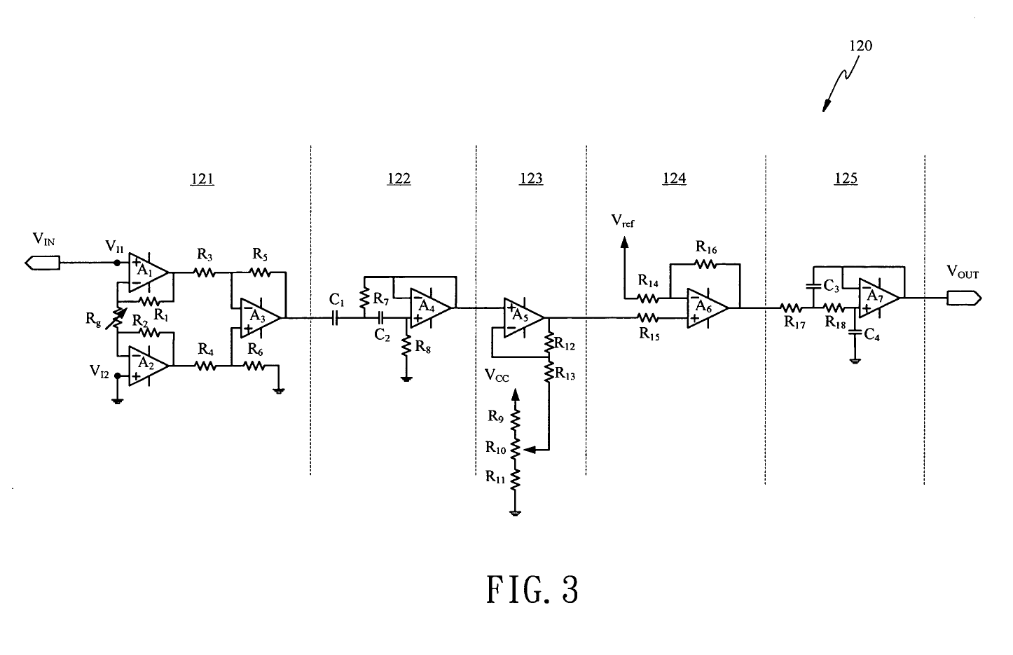

Referring to FIG. 3, which shows an equivalent circuit diagram of the analog signal processing unit 120 according to a preferred embodiment of the present invention. An instrumentation amplifier circuit 121 is used to receive and amplify the sensing signal outputted by the sensing unit 110 and output a first signal. The instrumentation amplifier 121 has electrical characteristics such as high common-mode rejection ratio, high input impedance and low output impedance, thus it is used as a first stage read-out circuit of the analog signal processing unit 120 to increase the signal-to-noise (S/N) ratio of the output end versus the original sensing signal, and is particularly useful for extracting small voltage signal of the sensing unit 110.

A high-pass filtering circuit 122 is used to receive and filter the first signal outputted by the instrumentation amplifier 121 and output a second signal, wherein the high-pass filtering circuit 122 includes a second-order high-pass Butterworth filter, which filters out DC offset voltage of the first signal based on its electrical characteristics such as pole setting and bandwidth modulation, thus maintaining high S/N ratio and increasing output signal quality.

A gain amplifying circuit 123 is used to receive and amplify the second signal outputted by the high-pass filtering circuit 122 and output a third signal, wherein the second signal is adjusted, that is, amplified from small to an appropriate level to facilitate subsequent processes.

A level adjusting circuit 124 is used to receive and perform level adjustment on the third signal outputted by the gain amplifying circuit 123 and output a fourth signal, wherein the third signal is adjusted to an appropriate level, such that the outputted fourth signal may comply with the input limit and specifications of the analog/digital converter.

A low-pass filtering circuit 125 is used to receive and filter the fourth signal outputted by the level adjusting circuit 124 and output the aforementioned front-end signal, wherein the low-pass filtering circuit 125 includes a second-order low-pass Butterworth filter, which filters out external unwanted noise (e.g. 60 Hz noise of power grid) to maintain high S/N ratio and increase output signal quality. The main goal of the above circuits of the analog signal processing unit 120 is to maintain high S/N ratio of the sensing signal of the sensing unit 110, that is, to maintain high noise margin (i.e. 0 dB) for the output-end S/N ratio compared to the input-end S/N ratio. This enhances subsequent quantification efficiency of the analog/digital converter, and achieves the resolution required by the portable multi-ions sensing system of the present invention.

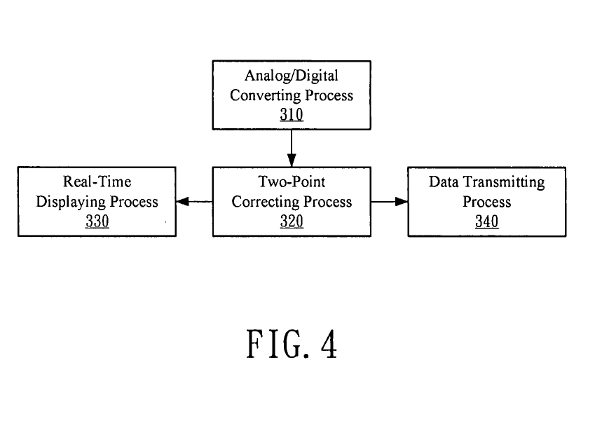

Referring to FIG. 4, which shows a data processing flow diagram of the microcontroller unit 130 according to a preferred embodiment of the present invention. An analog/digital converting module receives the front-end signal outputted by the signal processing unit 120 and performs an analog/digital conversion process 310 to output a fifth signal, where the analog/digital conversion process controls the analog/digital module of the microcontroller unit, including controls of sampling rate, channel selection and reference voltage level etc. A two-point correcting module receives the fifth signal outputted by the analog/digital converting module and performs a two-point correcting process to output the abovementioned measurement data. A real-time displaying module receives the measurement data outputted by the two-point correcting module and performs a real-time displaying process 330 to display the measurement data on the real-time display unit 140, such as LCD etc. In another embodiment, the microcontroller unit 130 further includes a data transmitting module that receives the measurement data outputted from the two-point correcting module and performs a data transmitting process 340 to transmit the measurement data out of the microcontroller unit 130, wherein the data transmitting module includes a USB interface and/or a USART interface. In this present invention, the microcontroller unit 130 can be a PIC18F452 single-chip microcontroller, but the present invention is not limited to this.

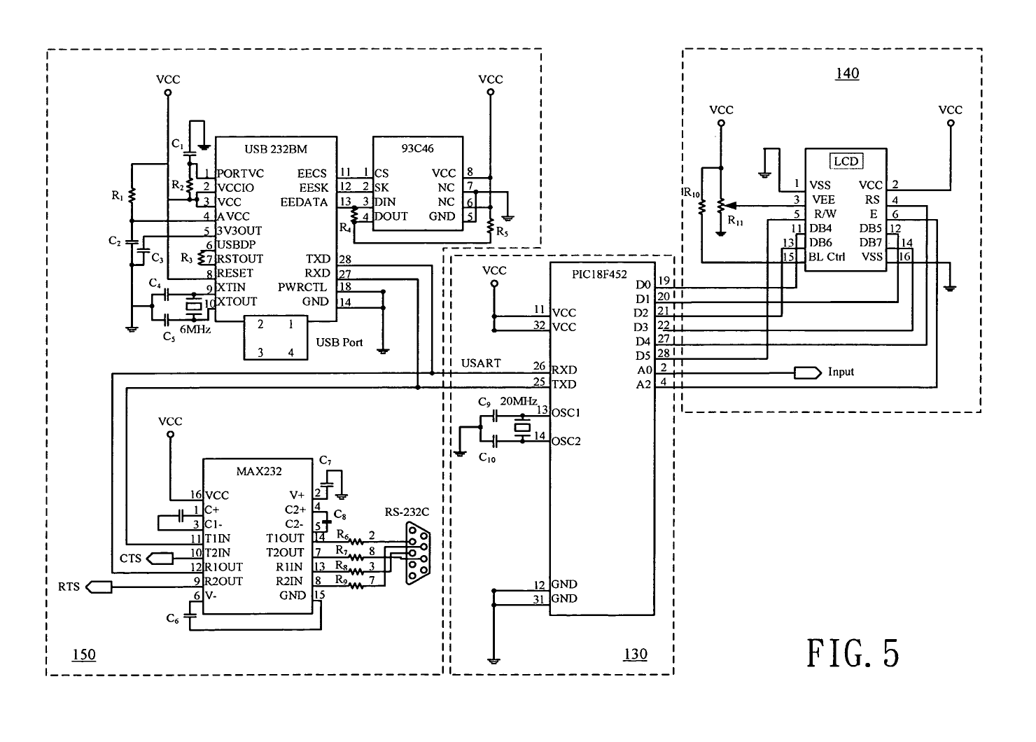

Referring to FIG. 5, which is an equivalent circuit diagram depicting connectivity between the microcontroller unit 130 (PIC18F452) and the real-time display unit 140 (LCD) and the data transmitting unit 150 according to a preferred embodiment of the present invention.

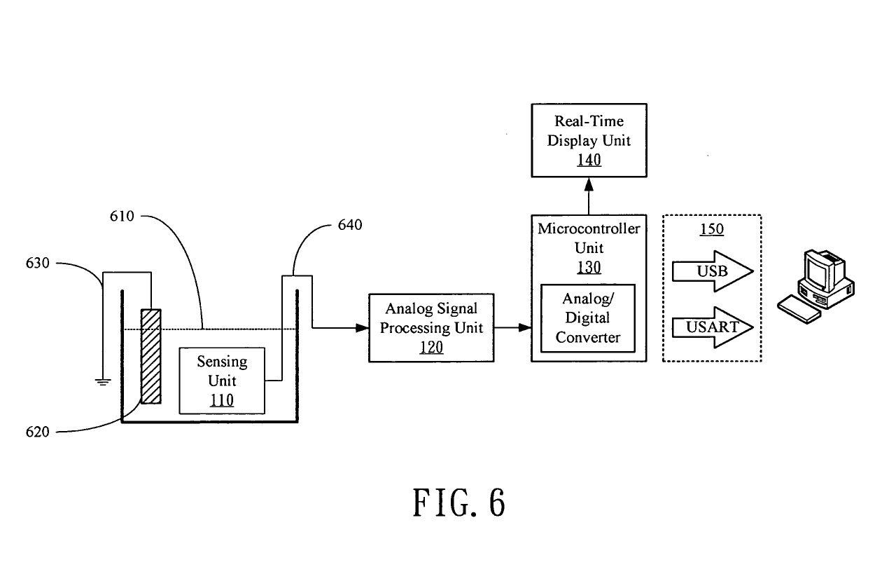

Referring to FIG. 6, which is a schematic diagram depicting the system according to a preferred embodiment of the present invention. A sensing unit 110 is a transducer for measuring a solution to be tested 610. The structure of the sensing unit 110 is the same as that shown in FIG. 2, so it will not be further described. A reference electrode 620 is a part of the sensing element 110 connected to ground via a first lead 630, thereby providing a stable reference potential during measurement. The reference electrode 630 includes a glass electrode, for example, a silver/silver chloride glass electrode. An analog signal processing unit 120 receives the sensing signal outputted by the sensing unit 110 via a second lead 640 and filters, amplifies, adjusts the level of the sensing signal to output a front-end signal. A microcontroller 130 receives and performs analog/digital converting and two-point correcting processes on the front-end signal to output a measurement data. A real-time display unit 140 receives and displays the measurement data, wherein the display unit 140 includes a LCD. A data transmitting unit 150 receives the measurement data and transmits it out of the portable multi-ions sensing system to, for example, a personal computer, wherein the data transmitting unit 150 includes USB and USART devices.

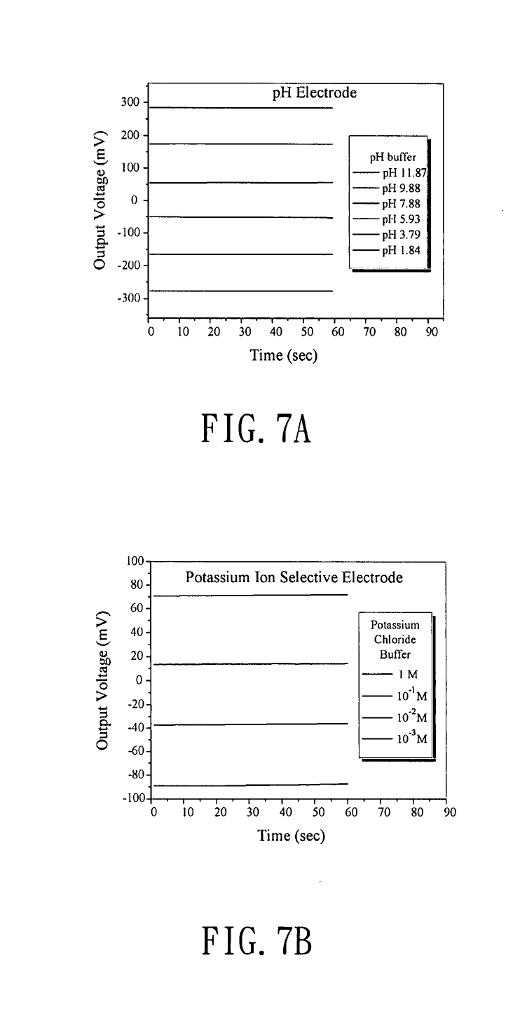

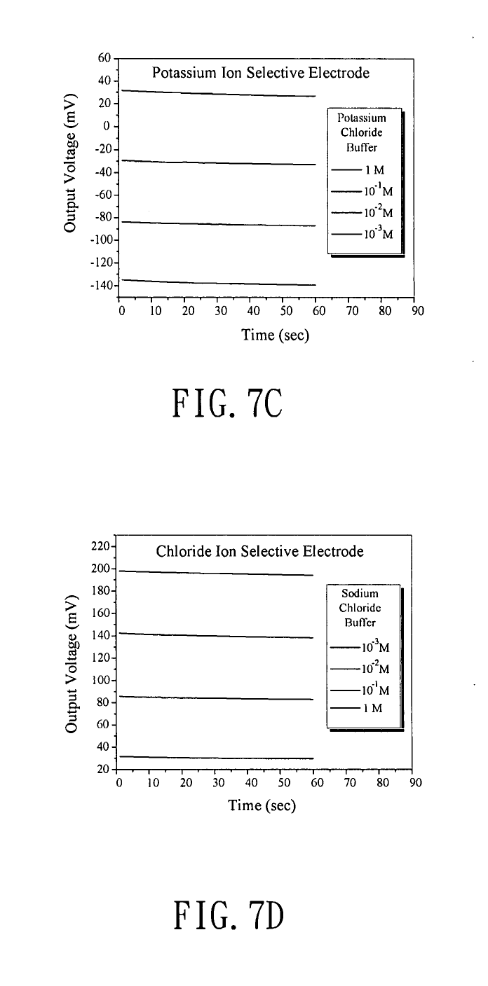

Referring to FIGS. 7A˜7D, which are graphs depicting steady-state output voltages for a pH electrode, a potassium ion selective electrode, a sodium ion selective electrode, and a chloride ion selective electrode of a preferred portable multi-ions sensing system of the present invention, respectively. As can be seen from the experimental results, the output voltage is held stable over time.

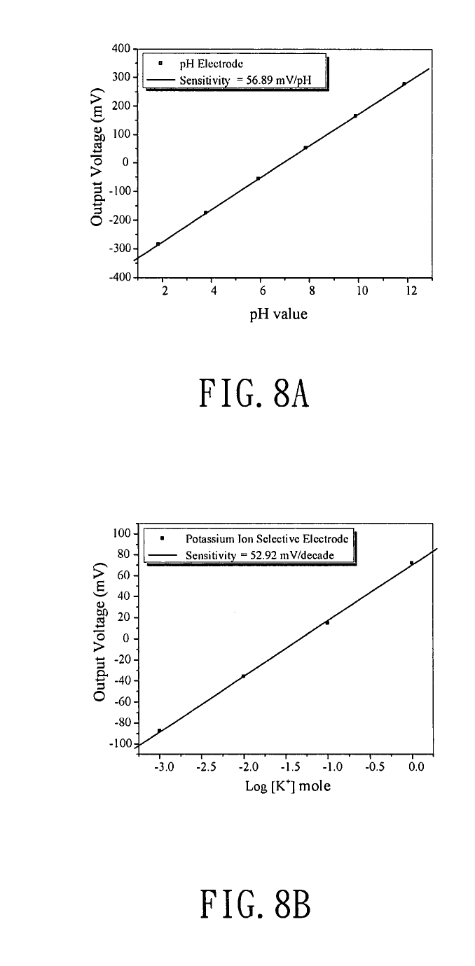

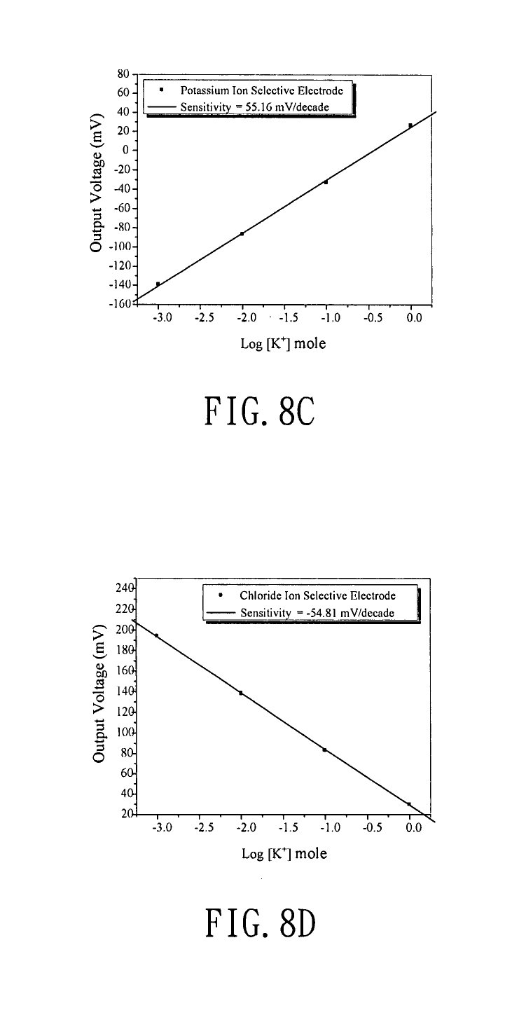

Referring to FIGS. 8A˜8D, which are graphs depicting correction curves for the pH electrode, the potassium ion selective electrode, the sodium ion selective electrode, and the chloride ion selective electrode of a preferred portable multi-ions sensing system of the present invention, respectively. As can be seen from the experimental results, sensitivities of the above electrodes are 56.89 mV/pH, 52.92 mV/decade, 55.16 mV/decade, and −54.81 mV/decade, respectively.

Referring to Table 1 below, which shows measured results of a pH electrode of a preferred portable multi-ions sensing system of the present invention in different pH buffers (pH2˜pH12). Compared to a commercialized pH meter that has measurement values of 2.11, 3.94, 5.96, 7.54, 9.63 and 11.46, respectively, the portable multi-ions sensing system of the present invention displays and transmits values of 2.26, 4.04, 6.14, 7.12, 9.33 and 11.28, respectively, via the LCD, USB, and RS232 modules. The error (%) between the commercialized pH meter and that of the present invention is relatively small (in the error range of 2%˜7%), which indicates the sensing system of the present invention has good performance and potential for market development.

TABLE 1
Measurements of a pH electrode of a preferred portable multi-ions
sensing system of the present invention in different pH buffers.

| | Measurement (pH value) | | | |
|---|---|---|---|---|
| Commercialized pH Meter | | | RS232 | Error |
| (pH value) | LCD module | USB module | module | (%) |
| 2.11 | 2.26 | 2.26 | 2.26 | 7 |
| 3.94 | 4.04 | 4.04 | 4.04 | 2 |
| 5.96 | 6.14 | 6.14 | 6.14 | 3 |
| 7.54 | 7.12 | 7.12 | 7.12 | 5 |
| 9.63 | 9.33 | 9.33 | 9.33 | 3 |
| 11.46 | 11.28 | 11.28 | 11.28 | 2 |

Referring to Table 2 below, which shows measured results of a potassium ion selective electrode of a preferred portable multi-ions sensing system of the present invention in different potassium chloride buffers (10⁻³M ˜1M). When the potassium chloride buffers are 1M, 10⁻¹M, 10⁻²M, and 10⁻³M, respectively, the portable multi-ions sensing system of the present invention displays and transmits values of 0.841M, 0.123M, 0.025M and 0.001M, respectively, via the LCD, USB, and RS232 modules. The errors in the measured results are in the acceptable range.

TABLE 2
Measurements of a potassium ion selective electrode of a preferred
portable multi-ions sensing system of the present invention in
different potassium chloride buffers (10⁻³M~1M).

| Potassium Chloride Buffer | Measurement (M) | | |
|---|---|---|---|
| (KCl_{(eq)} (M)) | LCD module | USB module | RS232 module |
| 1 | 0.841 | 0.841 | 0.841 |
| 10⁻¹ | 0.123 | 0.123 | 0.123 |
| 10⁻² | 0.025 | 0.025 | 0.025 |
| 10⁻³ | 0.001 | 0.001 | 0.001 |

Referring to Table 3 below, which shows measured results of a sodium ion selective electrode of a preferred portable multi-ions sensing system of the present invention in different sodium chloride buffers (10⁻³M ˜1M). When the potassium chloride buffers are 1M, 10⁻¹M, 10⁻¹M, and 10⁻³M, respectively, the portable multi-ions sensing system of the present invention displays and transmits values of 0.815M, 0.135M, 0.029M and 0.001M, respectively, via the LCD, USB, and RS232 modules. The errors in the measured results are within the acceptable range.

TABLE 3
Measurements of a sodium ion selective electrode of a preferred
portable multi-ions sensing system of the present invention in
different sodium chloride buffers (10⁻³M~1M).

| Sodium Chloride Buffer | Measurement (M) | | |
|---|---|---|---|
| (NaCl_{(eq)} (M)) | LCD module | USB module | RS232 module |
| 1 | 0.815 | 0.815 | 0.815 |
| 10⁻¹ | 0.135 | 0.135 | 0.135 |
| 10⁻² | 0.029 | 0.029 | 0.029 |
| 10⁻³ | 0.001 | 0.001 | 0.001 |

Referring to Table 4 below, which shows measured results of a chloride ion selective electrode of a preferred portable multi-ions sensing system of the present invention in different sodium chloride buffers (10⁻³M˜1M). When the potassium chloride buffers are 1M, 10⁻¹M, 10⁻²M, and 10⁻³M, respectively, the portable multi-ions sensing system of the present invention displays and transmits values of 0.931M, 0.136M, 0.019M and 0.001M, respectively, via the LCD, USB, and RS232 modules. The errors in the measured results are in the acceptable range.

TABLE 4
Measurements of a chloride ion selective electrode of a preferred
portable multi-ions sensing system of the present invention in
different sodium chloride buffers (10⁻³M~1M).

| Sodium Chloride Buffer | Measurement (M) | | |
|---|---|---|---|
| (NaCl_{(eq)} (M)) | LCD module | USB module | RS232 module |
| 1 | 0.913 | 0.913 | 0.913 |
| 10⁻¹ | 0.136 | 0.136 | 0.136 |
| 10⁻² | 0.019 | 0.019 | 0.019 |
| 10⁻³ | 0.001 | 0.001 | 0.001 |

Referring to Table 5, which shows specifications for a preferred portable multi-ions sensing system of the present invention. However, it should be noted that the measurement data shown in Tables 1, 2, 3 and 4 and the specifications in Table 5 are for illustrative purpose only, not limitation of the present invention.

TABLE 5
Specifications of a preferred portable multi-ions sensing
system of the present invention

| | |
|---|---|
| Types of Measurement | pH, pK, pNa and pCl |
| Measuring Methods | pH electrode and ISE |
| Measuring Range | pH: 2~12 |
| | ISE: 10⁻³ M~1 M |
| Measuring Environment | Room Temperature ~50 □ |
| Resolution | pH: 0.01 |
| | ISE: 10⁻³ M |
| Correcting Method | pH: 4 and 7 (two-point correction) |
| | ISE: 10⁻³ M and 10⁻¹ M |
| Output Functionality | LCD, USB and RS232 |
| Power Supply | 9 VDC (battery) |
| Size | 220 mm × 135 mm × 85 mm |
| | (L × W × D) |

In summary, the portable multi-ions sensing system of the present invention is achieved by combining semiconductor processes and embedded system technique. The sensing elements of the present invention utilize a pH electrode of a separative structure made from tin dioxide/ITO/glass etc. as the basis, and combined with a plurality of ion selective layers (films) and the embedded system technique. The portable multi-ions sensing system of the present invention can be applied for detecting multiple ion concentrations at a low cost and in mass production.

The foregoing description is not intended to be exhaustive or to limit the invention to the precise forms disclosed. Obvious modifications or variations are possible in light of the above teachings. In this regard, the embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the inventions as determined by the appended claims when interpreted in accordance with the breath to which they are fairly and legally entitled.

It is understood that several modifications, changes, and substitutions are intended in the foregoing disclosure and in some instances some features of the invention will be employed without a corresponding use of other features. Accordingly, it is appropriate that the appended claims be construed broadly and in a manner consistent with the scope of the invention.

1. A portable multi-ions sensing system, including:
a sensing unit for sensing a pH value and a plurality of ion concentrations of a solution and outputting a sensing signal, wherein the sensing unit includes:
a substrate;
an indium tin oxide (ITO) layer on the substrate;
a sensing layer on the ITO layer and connected with an extended lead;
a packaging layer encapsulating the sensing layer, the ITO layer and a portion of the substrate with a sensing window for exposing a portion of the sensing layer;
a multi-ions selective layer on the portion of the sensing layer exposed by the sensing window for sensing the plurality of ion concentrations; and
a reference electrode for providing a reference potential for the sensing layer;
an analog signal processing unit for receiving, filtering, amplifying and adjusting the level of the sensing signal and outputting a front-end signal;
a microcontroller unit for receiving and performing analog/digital converting and two-point correcting processes on the front-end signal and outputting a measurement data; and
a real-time display unit for receiving and displaying the measurement data.

2. A portable multi-ions sensing system of claim 1, further including a data transmitting unit for transmitting the measurement data out of the portable multi-ions sensing system.

3. A portable multi-ions sensing system of claim 2, wherein a transmission interface of the data transmitting unit includes a universal serial bus (USB).

4. A portable multi-ions sensing system of claim 2, wherein a transmission interface of the data transmitting unit includes a Universal Synchronous Asynchronous Receiver Transmitter (USART).

5. A portable multi-ions sensing system of claim 1, wherein the substrate includes an insulating substrate.

6. A portable multi-ions sensing system of claim 5, wherein the insulating substrate includes a ceramic substrate.

7. A portable multi-ions sensing system of claim 5, wherein the insulating substrate includes a glass substrate.

8. A portable multi-ions sensing system of claim 1, wherein the thickness of the ITO layer is approximately 230 angstroms.

9. A portable multi-ions sensing system of claim 1, wherein the sensing layer includes a tin dioxide layer.

10. A portable multi-ions sensing system of claim 9, wherein the thickness of the tin dioxide layer is approximately 2,000 angstroms.

11. A portable multi-ions sensing system of claim 1, wherein the extended lead includes a silver wire.

12. A portable multi-ions sensing system of claim 1, wherein the packaging layer includes epoxy resin.

13. A portable multi-ions sensing system of claim 1, wherein the area of the sensing window is 2×2 mm².

14. A portable multi-ions sensing system of claim 1, wherein the multi-ions selective layer includes a potassium ion selective layer.

15. A portable multi-ions sensing system of claim 1, wherein the multi-ions selective layer includes a sodium ion selective layer.

16. A portable multi-ions sensing system of claim 1, wherein the multi-ions selective layer includes a chloride ion selective layer.

17. A portable multi-ions sensing system of claim 1, wherein the reference electrode includes a silver/silver chloride glass electrode.

18. A portable multi-ions sensing system of claim 1, wherein the analog signal processing unit includes:
an instrumentation amplifying circuit for receiving and amplifying the sensing signal and outputting a first signal;
a high-pass filtering circuit for receiving and filtering the first signal and outputting a second signal;
a gain amplifying circuit for receiving and amplifying the second signal and outputting a third signal;
a level adjusting circuit for receiving and adjusting the level of the third signal and outputting a fourth signal; and
a low-pass filtering circuit for receiving and filtering the fourth signal and outputting the front-end signal.

19. A portable multi-ions sensing system of claim 18, wherein the high-pass filtering circuit includes a second-order high-pass Butterworth filter.

20. A portable multi-ions sensing system of claim 18, wherein the low-pass filtering circuit includes a second-order low-pass Butterworth filter.

21. A portable multi-ions sensing system of claim 1, wherein the microcontroller unit includes:
an analog/digital converting module for receiving and performing analog/digital conversion on the front-end signal and outputting a fifth signal;
a two-point correcting module for receiving and performing a two-point correcting process on the fifth signal and outputting the measurement data; and
a real-time displaying module for receiving and displaying the measurement data on the real-time displaying unit.

22. A portable multi-ions sensing system of claim 21, wherein the microcontroller unit further includes a data transmitting module for receiving and transmitting the measurement data out of the microcontroller unit.

23. A portable multi-ions sensing system of claim 22, wherein a transmission interface of the data transmitting module includes a universal serial bus (USB).

24. A portable multi-ions sensing system of claim 22, wherein a transmission interface of the data transmitting module includes a Universal Synchronous Asynchronous Receiver Transmitter (USART).

25. A portable multi-ions sensing system of claim 1, wherein the real-time display unit includes a liquid crystal display.
